(19) United States
(12) Patent Application Publication
(10) Pub. No.: US 2012/0195759 A1
(43) Pub. Date: Aug. 2, 2012

(54) Wind Turbine

(76) Inventor: Phil Feldhaus, Lake Village, IN (US)

(21) Appl. No.: 13/086,148

(22) Filed: Apr. 13, 2011

Related U.S. Application Data
(60) Provisional application No. 61/342,343, filed on Apr. 13, 2010.

(51) Int. Cl. F03D 3/06

(52) U.S. Cl. 416/117

(57) ABSTRACT

A wind turbine with a vertical axle supporting a plurality of frame assemblies is mounted to the axle in spaced apart radial positions wherein each of the frame assemblies has a vertically oriented flat screen fixed between a pair of spaced apart struts, a stationary or rotating arm is vertically oriented and mounted between the struts and to one side of the screen, and a flexible sheet is fixedly mounted along one of its edges to the stationary arm. With a wind blowing in any direction, at least one of the flexible sheets is positioned for being blown against one of the flat screens, thereby driving the axle in rotation, and at least one of the flexible sheets is positioned for being blown away from one of the flat screens thereby lowering wind resistance.

### CROSS-REFERENCE TO RELATED APPLICATIONS

This application is a non-provisional application describing the same invention as an active provisional application, Ser. No. 61/342,343, filed on Apr. 13, 2010, and being filed within one year, hereby claims date priority therefrom and is incorporated herein by reference.

### BACKGROUND

The present disclosure relates to the field of wind driven turbines, i.e., wind engines. Conventionally, a wind engine is classified as a horizontal axis wind engine or a vertical axis wind engine based on the orientation of rotating axes of its vanes. For vanes of the vertical axis wind engine they are pivotally mounted in a frame, The frame is fixedly coupled to a vertical axis. Its transmission is provided near the ground. To the contrary, in the horizontal axis wind engine each vane has its horizontal axis provided above the ground by a relatively long distance Moreover, each of a plurality of vanes of a vertical axis wind engine can adapt itself to wind by providing a wide contour in a windward condition for fully taking advantage of the force of wind and thus for generating larger torque. To the contrary, each vane can adapt itself to wind by providing a narrow contour in a leeward. condition for decreasing wind friction. As an end, wind's rotation on the vanes can be maximized for rotating the wind engine. As such, many power companies have spent much time and cost in research and development of commercial wind engines which almost all are vertical axis type wind engines due to the above reasons. The vertical axis wind engine comprises a plurality of vanes of fiat surface each pivotally mounted near a free end of one of a plurality of arms of a star configuration. The arms are adapted to rotate in response to wind blowing over surfaces of the vanes. Also, the vanes orbit a central, vertical axis. Each vane can adapt itself to wind by providing a wide contour in a windward condition for fully taking advantage of the force of wind, To the contrary, each vane can adapt itself to wind by providing a narrow contour in a leeward condition for decreasing wind. friction. In prior art wind turbines, an abrupt operation often occurs when the wind engine rotates. That is, its operation is not smooth. Further, the vanes tend to cause the wind engine to rotate intermittently due to centrifugal force. As such, the rotating speed of the wind engine may decrease greatly. And in turn, both the arms and the vertical axis rotate in a speed less than wind speed. The presently described wind turbine avoids this problem by providing very low mass vanes.

### SUMMARY

The present wind turbine has a vertical axle supporting a plurality of vertical frame assemblies mounted to the axle in spaced apart radial positions wherein each of the frames has a vertical flat screen fixed between a pair of spaced apart struts or arms extending from the axle, a stationary or rotating arm is vertically oriented and mounted between the struts and to one side of the screen, and one or more of flexible sheets are each fixedly mounted along one edge to the stationary or rotary arms. With a wind blowing in any direction, at least one of the flexible sheets is positioned for being blown against its adjacent flat screen, thereby driving the frame and thus the axle in rotation. At the same time, at least one of the flexible sheets is positioned for being blown away from its adjacent flat screen to decrease wind resistance.

In one aspect of the present turbine, the sheets have ultra-low mass, so as to quickly move against and away from their adjacent screens, thereby utilizing wind impact more efficiently.

in another aspect, because the sheets are of low mass, the supporting structure of the turbine may be less robust establishing a low mass to the rotating portion of the turbine. With a low mass, the turbine is more effective in turning wind energy into rotational torque.

In another aspect, each of the sheets may be fixed along one of its edges to a rotating arm which is mounted in bearing surfaces or roller bearings. This allows the sheets to move between its preferred positions very quickly, once more contributing to the efficiency of the presently described turbine.

The details of one or more embodiments of these concepts are set forth in the accompanying drawings and the description below. Other features, objects, and advantages of these concepts will be apparent from the description and drawings, and from the claims.

### DESCRIPTION OF DRAWINGS

FIG. 1 is an example plan view of one embodiment of the presently described wind. turbine apparatus;

FIG. 2 is a partial perspective view thereof as seen sighting along arrow A in FIG. 1 showing one frame assembly of the turbine as mounted to a central axle; and

FIG. 3 is a partial perspective view thereof as seen sighting along arrow B in FIG. 1, again showing one frame assembly of the turbine as mounted to a central axle;

Like reference symbols in the various drawings indicate like elements.

### DETAILED DESCRIPTION

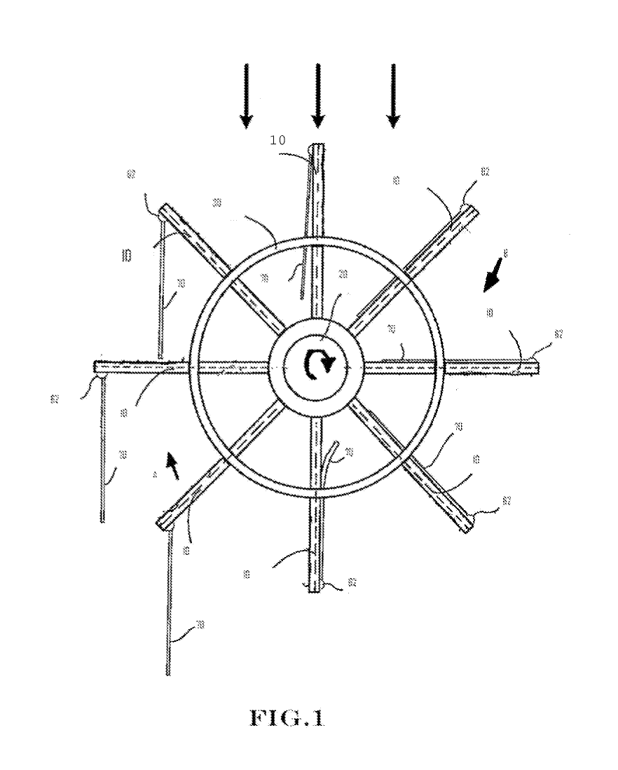

FIG. 1 shows a top plan view of a driving portion of a wind turbine comprising a plurality of frame assemblies 10 mounted to a vertical axle 20 in spaced apart radial positions. A rigid circular support 30 may be coaxially positioned with respect to the vertical axle 20 and engaged with struts 40 of the frame assemblies 10 to provide a rigidizing influence over the entire rotating portion of the turbine. Many other structural systems may be utilized to assure that the frame assemblies 10 are maintained in their positions.

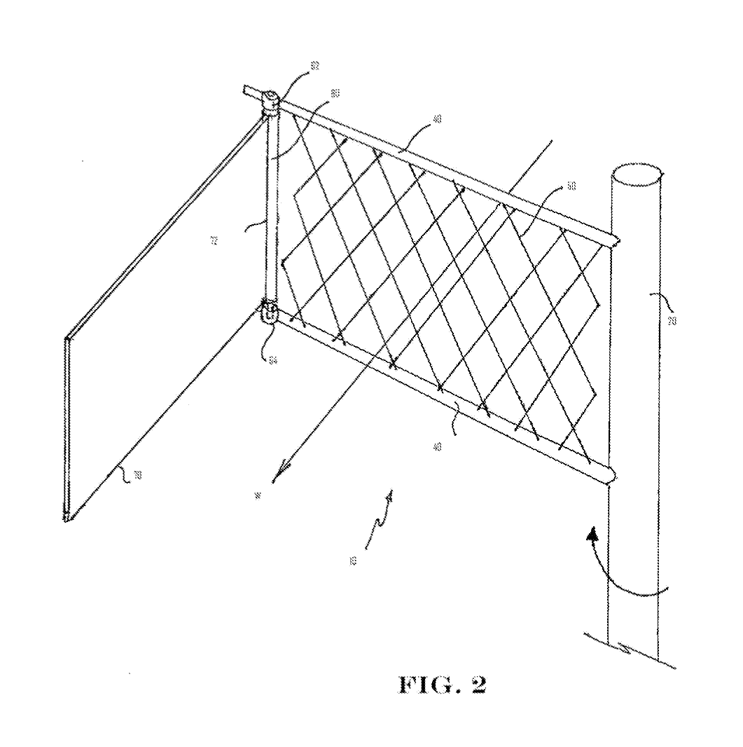

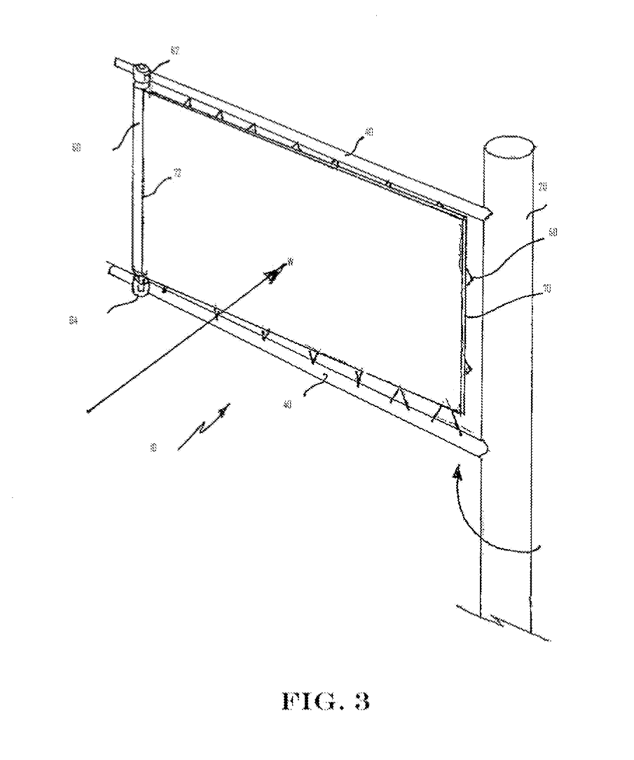

FIG. 2 illustrates a typical one of the frame assemblies 10 of the driving portion of the wind turbine, Each of the frame assemblies 10 has a vertically oriented flat screen 50 fixed between a pair of spaced apart struts 40, and a pivot arm 60 which is vertically oriented and rotationally mounted between the struts 40 within upper 62 and lower 64 bearings. Arm 60 may also be non-rotating. As shown, arm 60 is positioned to one side of screen 50. A flexible sheet 70 is fixedly mounted along one of its edges 72 to arm 60. The bearings 62 and 64 are attached to struts 40. As shown in FIG. 2, the screen 50 may be of the type made up of crisscross wire construction or may be of other structural wire fabric construction with relatively open weave to minimize wind drag by allowing the maximum amount of wind to flow through screen 50 with least resistance. FIG. 2 shows a frame 10 with sheet 70 positioned away from screen 50. FIG. 3 shows a frame assembly 10 with its sheet 70 pressed against screen 50.

The operation of the wind turbine described above and shown in the figures is readily understood. FIG. 1 shows the direction of the wind with three heavy arrows at the twelve o'clock position in the figure. The wind force impacts the frame assemblies 10 on the right side of the turbine by pressing sheets 70 against their respective screens 50 as illustrated in FIG. 3. The sheets 70 may be a light weight and highly flexible, impermeable fabric such as plastic sheeting or other material. At the same time, the wind flowing around the left side of the turbine forces the sheets 70 away from their respective screens 50 as shown in FIG. 1. As the turbine rotates, in the present case, as shown in FIG. 1, in a clockwise direction, each frame assembly 10 moving through the 12 o'clock position receives a wind force pinning the sheet 70 of that frame assembly 10 against its screen 50. As that frame assembly 10 moves from 12 o'clock to 6 o'clock it is subject to wind forces that deliver driving forces to the turbine. At the 6 o'clock position, as shown in FIG. 1, the sheet 70 starts to be delaminated from its screen 50 by wind forces, and moves to the position shown by the other frame assemblies 10 on the left side of the turbine. Wind. resistance of those frame assemblies 10 is light since the wind moves easily through the screens 50 and the sheets 70 are aligned with the wind direction so that they offer little wind resistance. In summary then, each of the frame assemblies 10 participate in generating turbine power as they move between the 12 and 6 o'clock positions and provide little wind resistance as they move between the 6 and 12 o'clock to thereby produce a clockwise rotation as viewed from above the machine.

It should be noted that the wind may change direction or have an inconsistent direction. Because the sheets 70 have little mass they quickly move between positions of contact and no-contact with screens 50. Therefore, the presently described turbine has an improved ability to adjust to wind conditions and to draw as much turbine power from the wind as possible. Prior an turbines have blades or paddles which are more massive and therefore less responsive to wind changes and slow to assume a closed position at the 12 o'clock position and an open position at the 6 o'clock position. This results in a loss of power in these prior art turbines. With the wind directed at the turbine from any direction, at least one of the flexible sheets 70 is positioned against one of the flat screens 50, thereby driving the axle 20 in rotation, and at least one of the flexible sheets 70 is positioned away from its screen 50 so as to eliminate wind drag.

It should be recognized that the embodiment shown in the figures of this disclosure define the concept of the present invention and that an actual turbine may not be constructed. exactly as shown. In a given frame assembly 10, the single pivot arm 60 engaged with a single sheet 70 shown in FIGS. 2 and 3, may easily be replaced by a plurality of such pivot arms 60 in spaced apart parallel positions along struts 40. The sheet 70 in that case will be replaced by a plurality of sheets each of smaller horizontal dimension but in composite will cover screen 50. Such a construction will resemble a vertical window blind but replacing the window blind's rigid slat with the low mass and highly flexible material of sheet 70. Clearly, a similar construction may be used with vertically spaced apart, horizontally oriented pivot arms so that the sheets rotate downwardly to close against screen 50, and rotate upwardly when they are forced to move away from screen 50. It also should be realized that the pivot arms 60 may be replaced by fixed, non-rotating arms since it is clear that sheets 70 may change position by merely bending at their junction with non-rotating arms. There are many ways by which sheet 70 may be joined fixedly to arm 60 including by inserting an edge of sheet 70 into a longitudinal slot in arm 60. FIGS. 2 and 3 illustrate a single frame assembly engaged with axle 20 and this might represent one set of such frame assemblies in a common horizontal position on axle 20. However, axle 20 may be quite long in the vertical direction and more than one set of frame assemblies might be mounted on axle 20 one above the next.

A number of embodiments have been described herein. Nevertheless, it will be understood that various modifications may be made without departing from the spirit and scope of this disclosure. Accordingly, other embodiments are within the scope of the following claims.

What is claimed is:

1. A wind turbine comprising:
a vertical axle;
a plurality of frame assemblies mounted to the axle in spaced apart radial positions;
each said frame assembly having:
a vertically oriented flat screen fixed between a pair of spaced apart struts, and
a pivot arm vertically oriented and rotationally mounted between the struts and to one side of the screen;
a flexible sheet fixedly mounted along one edge thereof to the pivot arm;
whereby, with a wind blowing in any direction, at least one of the flexible sheets is positioned for being blown against one of the flat screens, thereby driving the axle rotation, and at least one of the flexible sheets is positioned for being blown away from one of the flat screens.

2. The wind turbine of claim 1 wherein the pivot arm is secured between a pair of bearings.

3. The wind turbine of claim 1 wherein the plurality assemblies are between 4 and 8 in number.

4. The wind turbine of claim 1 wherein the flat screen is of crisscross wire construction.

5. The wind turbine of claim 1 further comprising a circular support coaxially positioned with the vertical axle and engaged with the struts of the frame assemblies.

6. A wind turbine comprising:
a vertical axle;
a plurality of frame assemblies mounted to the axle in spaced apart radial positions;
each said frame assembly having:
a vertically oriented flat screen fixed between a pair of spaced apart struts, and
a stationary arm vertically oriented and mounted between the struts and to one side of the screen;
a flexible sheet fixedly mounted along one edge thereof to the stationary arm;
whereby, with a wind blowing in any direction, at least one of the flexible sheets is positioned for being blown against one of the flat screens, thereby driving the axle in rotation, and at least one of the flexible sheets is positioned for being blown away from one of the flat screens.

7. The wind turbine of claim 1 wherein the pivot arm is secured between a pair of bearings.

8. The wind turbine of claim 1 wherein the plurality of frame assemblies are between 4 and 8 in number,

9. The wind turbine of claim 1 wherein the flat screen is of crisscross wire construction,

10. The wind turbine of claim 1 further comprising a circular support coaxially positioned with the vertical axle and engaged with the struts of the frame assemblies.
